(19) United States
(12) Patent Application Publication
(10) Pub. No.: US 2007/0264981 A1
(43) Pub. Date: Nov. 15, 2007

(54) Restricted feature access for portable electronic devices

(76) Inventor: Douglas Miller, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/413,436

(22) Filed: Apr. 28, 2006

(51) Int. Cl. H04Q 7/38; H04Q 7/22; H04M 3/42

(52) U.S. Cl. 455/414.1

(57) ABSTRACT

A portable communication device with a plurality of features accessible by a user. The portable communication device is configured to receive password information from a user and associate the received password information with at least one of the features. The password information, which may be associated with user profiles, may then be used to restrict access to certain of the features.

### TECHNICAL FIELD OF THE INVENTION

The present invention relates generally to portable electronic devices, and, more particularly, to a system and method for enabling restricted access to features of portable electronic devices.

### DESCRIPTION OF THE RELATED ART

In recent years, portable electronic devices, such as mobile phones, personal digital assistants (PDA), mobile terminals, portable digital music players (e.g., iPods, mp3 players), etc. have grown and continue to grow in popularity. At least anecdotally, it can be said that everyone seems to have a mobile phone these days.

Parents may desire to share their portable electronic devices, such as their mobile phone, with their child. For example, parents may wish to lend their mobile phone to their child so that the child can call home when it is time to be picked up. Some children, however, may not use their parent's cell phone responsibly. For example, children may use cell phones borrowed from parents to call friends even though they were instructed to use the phone only for emergencies or to call their parents. The child may also access the internet or send text messages via the mobile phone, incurring unwanted service charges. In addition, it may be desirable to prevent the child from viewing certain information stored on the mobile phone, such as calendar or contact information or stored files.

It would therefore be desirable if a portable electronic device owner were able to provide only restricted access to selected features on portable electronic devices when others are using the device.

### SUMMARY

One aspect of the present invention relates to a portable communication device. The portable communication device includes a user input mechanism; a plurality of features; and a feature restriction program loaded in memory communicably coupled to the user input mechanism, the feature restriction program being configured to enable restricted access to at least one of the plurality of features.

According to another aspect of the present invention, the feature restriction program is configured to require a user to enter security information before the user is able to access at least one of the plurality of features.

According to another aspect of the present invention, the feature restriction program is configured to enable the creation of user profiles for restricted access to at least one of the plurality of features.

According to another aspect of the present invention, the feature restriction program is configured to require a user to enter user profile information after the portable communication device is powered on.

According to another aspect of the present invention, the feature restriction program is configured to restrict at least one of: incoming calls; outgoing calls; incoming text messages; outgoing text messages; incoming picture or video messages; outgoing picture or video messages; incoming email; outgoing email; instant messaging access; incoming instant messages, outgoing instant messages; internet access; game access; music access; camera access; accessing or editing contact information; accessing or editing calendar information; accessing or editing call history information; accessing or editing stored files; or accessing a wireless data transfer system.

According to another aspect of the present invention, restricting incoming calls comprises at least one of: restricting all incoming calls; restricting numbers from which incoming calls may be received; or restricting the time of connection for incoming calls.

According to another aspect of the present invention, restricting outgoing calls comprises at least one of: restricting all outgoing calls; restricting numbers which may be called; or restricting the time of connection for outgoing calls.

Another aspect of the present invention relates to a feature restriction program stored on a machine readable medium. The feature restriction program is suitable for use in a portable electronic device, and when it is loaded in memory in the portable electronic device and executed, the feature restriction program causes the portable electronic device to be configured at least in part: to receive user profile information comprising password information; and to enable restricted access to at least one of the plurality of features based upon the received user profile information.

According to another aspect of the present invention, the feature restriction program is configured to require a user to enter user profile information before the user is able to access at least one of the plurality of features.

According to another aspect of the present invention, the feature restriction program is configured to require a user to enter user profile information after the portable communication device is powered on.

According to another aspect of the present invention, the feature restriction program is configured to restrict at least one of: incoming calls; outgoing calls; incoming text messages; outgoing text messages; incoming picture or video messages; outgoing picture or video messages; incoming email; outgoing email; instant messaging access; incoming instant messages, outgoing instant messages; internet access; game access; music access; camera access; accessing or editing contact information; accessing or editing calendar information; accessing or editing call history information; accessing or editing stored files; or accessing a wireless data transfer system.

According to another aspect of the present invention, restricting incoming calls comprises at least one of: restricting all incoming calls; restricting numbers from which incoming calls may be received; or restricting the time of connection for incoming calls.

According to another aspect of the present invention, restricting outgoing calls comprises at least one of: restricting all outgoing calls; restricting numbers which may be called; or restricting the time of connection for outgoing calls.

Another aspect of the present invention relates to a method for restricting features on a portable electronic device. The method comprises receiving user profile information comprising password information at the portable electronic device; associating the received user profile information with at least one portable electronic device feature; receiving a user input requesting access to at least one portable electronic device feature; determining whether the at least one portable electronic device feature is associated with the received user profile information; and enabling the requested access to the at least one portable electronic device feature upon a positive determination in step d).

According to another aspect of the present invention, the method further comprising restricting access to the at least one portable electronic device feature upon a negative determination in step d).

According to another aspect of the present invention, the at least one portable electronic device feature is at least one of: receiving incoming calls; making outgoing calls; receiving incoming text messages; sending outgoing text messages; receiving incoming picture or video messages; sending outgoing picture or video messages; receiving incoming email; sending outgoing email; accessing instant messaging; receiving incoming instant messages, sending outgoing instant messages; accessing the internet; accessing a game; accessing music; accessing a camera; accessing or editing contact information; accessing or editing calendar information; accessing or editing call history information; accessing or editing stored files; or accessing a wireless data transfer system.

According to another aspect of the present invention, the method further comprises at least one of: restricting all incoming calls; restricting numbers from which incoming calls may be received; or restricting the time of connection for incoming calls.

According to another aspect of the present invention, the method further comprises at least one of: restricting all outgoing calls; restricting numbers which may be called; or restricting the time of connection for outgoing calls.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of an exemplary portable electronic device on which the present invention is carried out;

FIG. 2 is a flow chart illustrating a method according to the present invention for restricting features on a portable electronic device;

FIG. 3 is a flow chart illustrating an exemplary method according to the present invention for creating a user profile for restricted access to features of a portable electronic device FIGS. 4 and 5 are diagrammatic illustrations of restricted features associated with exemplary user profiles; and

FIG. 6 is a flow chart illustrating an exemplary method according to the present invention for restricting access to features of a portable electronic device based on user profiles.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “electronic equipment” includes portable electronic devices, such as portable digital music devices and portable radio communication devices. The term portable radio communication device, which hereinafter is referred to as a mobile phone, a mobile device, a mobile radio terminal or a mobile terminal, includes all devices, including, but not limited to, mobile telephones, pagers, communicators, i.e., electronic organizers, smartphones, personal digital assistants (PDAs), or the like. A portable radio communication device may also be a portable digital music device.

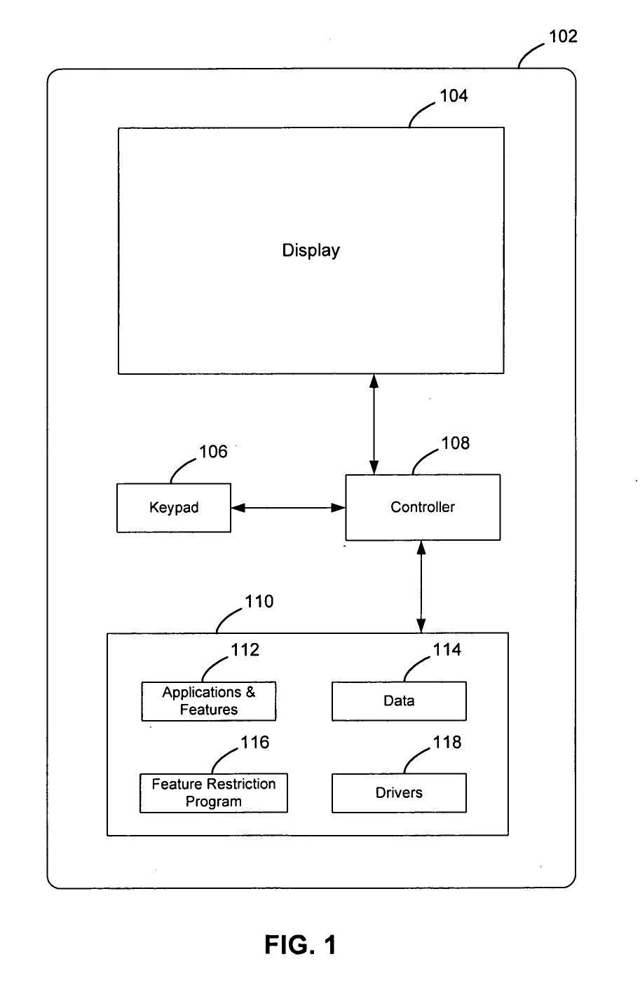

Referring initially to FIG. 1, provided is a diagrammatic illustration of an exemplary portable electronic device on which the present invention may be carried out. The portable electronic device 102 includes a display 104, user interface (shown as keypad 106), controller 108 and memory 110. In the memory 110 are stored applications and features 112 for running the portable electronic device 102. Also stored in the memory 110 are a feature restriction program 116, data 114 and applicable drivers 118 for operating the portable electronic device 102.

The display 104 may be any display and is preferably a liquid crystal display. The keypad 106 may be any keypad user input device. If the portable electronic device 102 is a mobile phone, the keypad 106 may be, for example, a numerical keypad or an alphanumerical keypad. In addition, the portable electronic device 102 may include additional user input mechanisms, such as a joystick, a wheel, a pointer and switch, a soft key, a touch screen and finger or stylus, biometric input mechanism such as a fingerprint or retinal scanner, etc.

The controller 108 controls the flow of information and operation of the portable electronic device 102. As will be understood by those skilled in the art, the controller 108 may be implemented as one or more combinations of the following: programmable circuit, integrated circuit, memory and I/O circuits, an application specific integrated circuit, microcontroller, complex programmable logic device, field programmable gate arrays, other programmable circuits, or the like.

The feature restriction program 116 is configured to enable restricted access to at least one of the features 112 of the portable electronic device 102. Thus, when the feature restriction program 116 is executed, the feature restriction program 116, in conjunction with the user input mechanism such as keypad 106, the controller 108 and the memory 110, causes the portable electronic device 102 to enable restricted access to at least one of the features 112 of the portable electronic device 102.

The feature restriction program 116 may be configured to enable the creation of user profiles for restricted access to features 112. The feature restriction program 116 may also be configured to receive user profile information via a user input mechanism. The user profile information preferably includes password information. The password information may be, for example, numeric, alphabetic, alphanumeric, biometric password information or any other type of password information and may be received via any type of user input mechanism. For example, the feature restriction program 116 may be configured to require a user to enter security information before the user is able to access a selected feature 112. In addition, the feature restriction program 116 may be configured to require a user to enter security information after the portable electronic device 102 is powered on and before a feature is selected.

The features 112 of the portable electronic device 102 may include, but are not limited to, receiving incoming calls, making outgoing calls, receiving incoming text messages, sending outgoing text messages, receiving incoming picture or video messages, sending outgoing picture or video messages, receiving incoming email, sending outgoing email, accessing instant messaging, receiving incoming instant messages, sending outgoing instant messages, accessing the internet, accessing a game, accessing music or video, accessing a camera, accessing or editing contact information, accessing or editing calendar information, accessing or editing call history information, accessing or editing stored files, or accessing a wireless data transfer system (e.g., Bluetooth, infrared, etc.).

The feature restriction program 116 may be configured to enable a variety of types of restricted access depending on the type of feature 112 and the level of restriction desired. For example, the feature restriction program 116 may be configured to restrict incoming calls so that all incoming calls are restricted (i.e., the user cannot receive calls), to restrict the numbers from which incoming calls may be received, or to restrict the time of connection for incoming calls. Similarly, the feature restriction program may be configured to restrict outgoing calls so that all outgoing calls are restricted (i.e., the user cannot make calls), to restrict the numbers which may be called (e.g., family members, 911, etc.), or to restrict the time of connection for outgoing calls.

Also, the feature restriction program 116 may be configured to completely restrict, or enable partially restricted text messaging, internet access, video messaging, or instant messaging. Other features 112 of the portable communication device 102 may also be restricted by the feature restriction program 116. These features 112 may include accessing games, music or video files, the portable electronic device camera, or a wireless data transfer system. The feature restriction program 116 may also act to restrict a user's ability to access or edit contact information, access or edit calendar information, access or edit call history information, or access or edit stored files. Restricting a user's ability to edit may involve restricting the user's ability to delete as well as the user's ability to change.

In the presently preferred embodiment, the portable electronic device 102, such as a mobile phone, contains a feature restriction program 116 that enables a first user (master user), such as a parent, to create multiple user profiles and associate different levels of feature accessibility with the multiple user profiles. Before the user accesses any of the features 112 of the portable electronic device 102, the feature restriction program 116 preferably requires the user to enter profile information, such as a username and password or a biometric information scan. The feature restriction program 116 preferably determines the level of accessibility that is associated with the profile matching the received user profile information. In this manner, a parent, for example, can create a user profile for a child and selectively grant or restrict access to various features 112 on the portable electronic device 102. When the child uses the parent's portable electronic device 102, the feature restriction program 116 preferably requires the child to enter user profile information before using any feature on the portable electronic device 102. The parent may have restricted the outgoing calls to family members and 911, for example. The feature restriction program 116 would then enable restricted access to outgoing calls based on the level of feature access associated with the user profile.

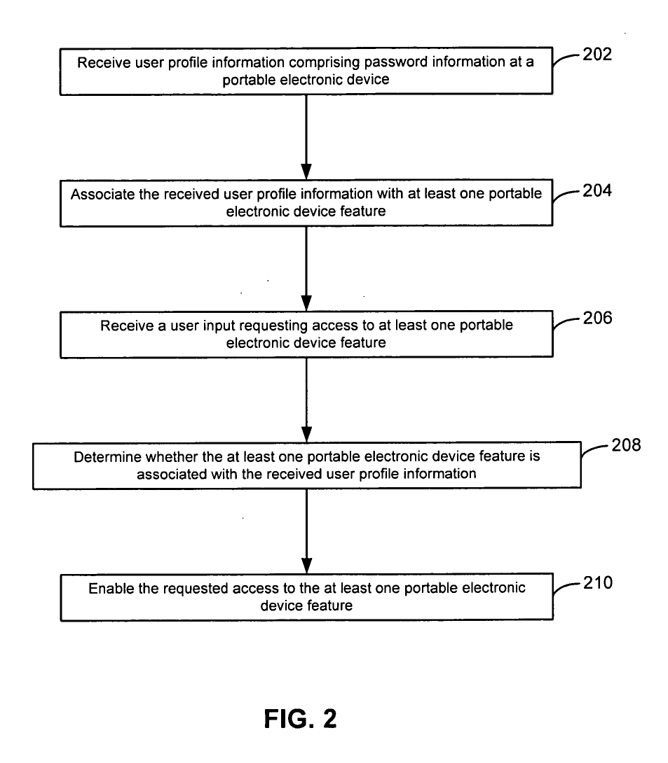

Turning next to FIG. 2, a flow chart illustrating a method according to the present invention for restricting features on a portable electronic device is provided. Flow begins at process block 202, wherein user profile information comprising password information is received at the portable electronic device. Flow then continues to process block 204. At process block 204, the received user profile information is associated with at least one portable electronic device feature. Progression then flows to process block 206 wherein a user input requesting access to at least one portable electronic device feature is received. Flow then continues to process block 208 wherein the feature restriction program determines whether the at least one portable electronic device feature is associated with the received user profile information. Progression then flows to process block 210 the feature restriction program enables the requested access to the at least one portable electronic device feature upon a positive determination in process block 208. The requested access may be full access or restricted access, depending on profile settings.

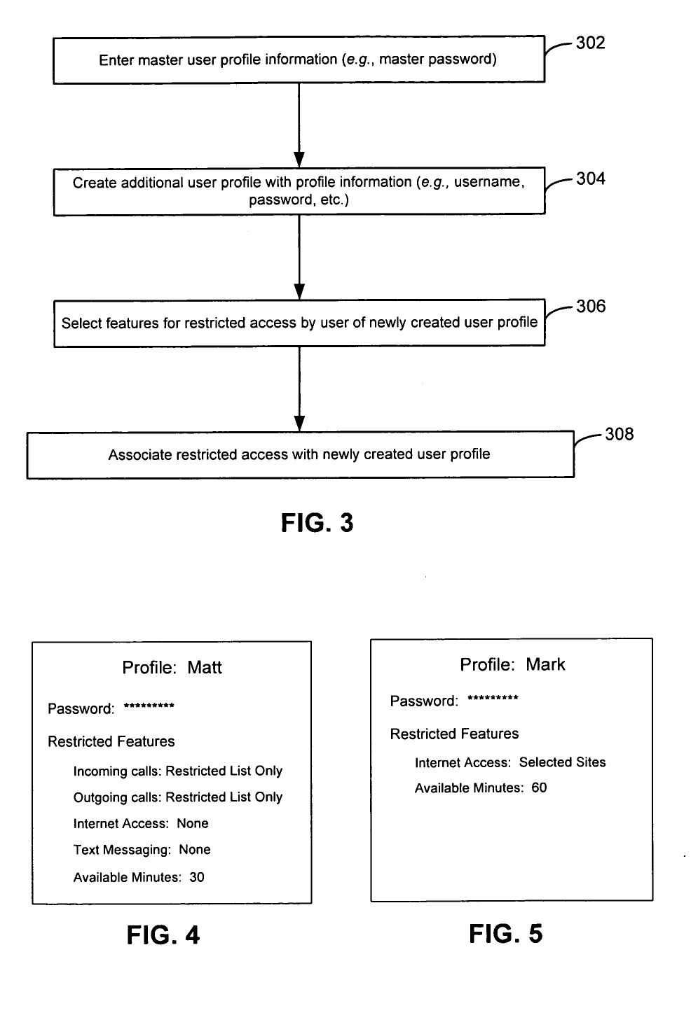

Turning next to FIG. 3, a flow chart illustrating an exemplary method for creating user profiles with restricted feature access is provided. The feature restriction program 116 of the present invention may allow a user to perform the steps illustrated in FIG. 3. Flow begins at process block 302, wherein master user profile information is received at the portable electronic device. The master user profile information may be, for example, a master password associated with unrestricted access to the portable electronic device. Flow then continues to process block 304. At process block 304, a new user profile is created with profile information such as a username and password. Progression then flows to process block 306 wherein restricted features are selected for association with the user profile. Flow then continues to process block 308 wherein selected features and restricted features are associated with the user profile.

Turning next to FIGS. 4 and 5, diagrammatic illustrations of restricted features associated with exemplary user profiles are provided. As shown in FIG. 4, the exemplary user profile for “Matt” can only make calls to and receive calls from numbers that are on a restricted phone number list. In addition, no internet access or text messaging is available to the profile of FIG. 4. Also, only 30 minutes of talk time are available to the profile of FIG. 4.

FIG. 5, however, is less restricted. There is no restriction on the recipients of outgoing calls or on the numbers from which incoming calls may be received. Internet access is enabled, but in a restricted manner. Only selected sites are available to the profile of FIG. 5. A parent may desire to prevent a child from viewing certain types of web content, just as a parent may restrict a child's access to the internet via a computer. Also, the profile of FIG. 5 has access to 60 minutes of talk time.

It should be understood that any feature of a portable communication device may be restricted or partially restricted. Thus, the present invention may be capable of enabling restricted access to almost any combination of features on a portable communication device.

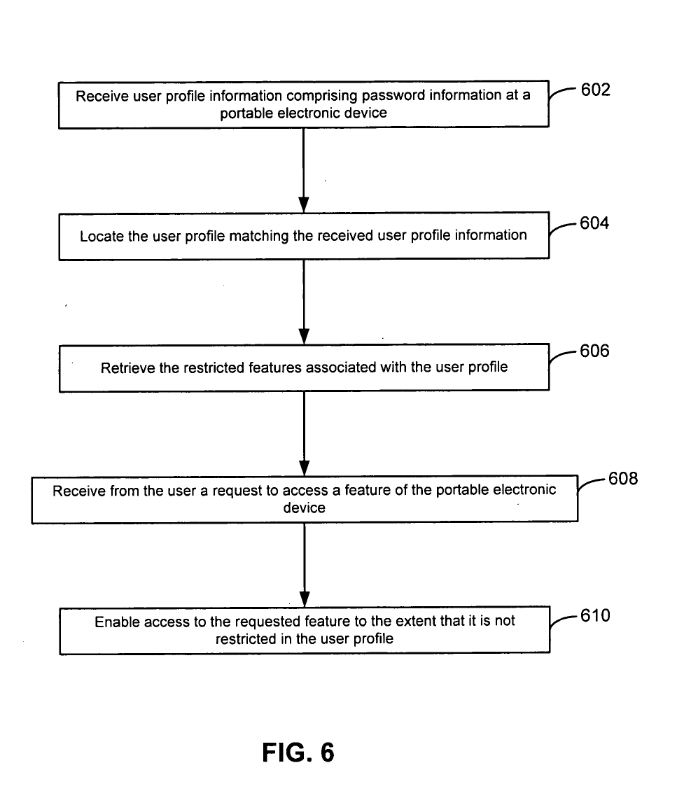

Turning next to FIG. 6, a flow chart illustrating an exemplary method according to the present invention for restricting access to features of a portable electronic device based on user profiles is provided. The feature restriction program 116 of the present invention may perform the steps illustrated in FIG. 6. Flow begins at process block 602, wherein user profile information is received at the portable electronic device. The user profile information may include password information. In addition, the user profile information may be received from the master user, thereby setting the access restrictions prior to allowing another user to user the device. The user profile information may also be received from another user, such as after the portable electronic device is powered on. Preferably, the feature restriction program of the present invention is capable of receiving user profile information from both a master user or from another user. Flow then continues to process block 604. At process block 604, a user profile matching the received user profile information is located. Progression then flows to process block 606 wherein the restricted features associated with the selected user profile are determined. Flow then continues to process block 608 wherein a request from a user to access a feature of the portable electronic device is received. Progression then continues to process block 610 wherein access to the requested feature is enabled to the extent that the requested feature is not restricted in the user profile.

While the present invention has been described primarily with reference to mobile phones, the present invention is not intended to be so limited. As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A portable communication device comprising:
a user input mechanism;
a plurality of features; and
a feature restriction program loaded in memory communicably coupled to the user input mechanism, the feature restriction program being configured to enable restricted access to at least one of the plurality of features.

2. The portable communication device of claim 1 wherein the feature restriction program is configured to require a user to enter security information before the user is able to access at least one of the plurality of features.

3. The portable communication device of claim 1 wherein the feature restriction program is configured to enable the creation of user profiles for restricted access to at least one of the plurality of features.

4. The portable communication device of claim 3 wherein the feature restriction program is configured to require a user to enter user profile information after the portable communication device is powered on.

5. The portable communication device of claim 1 wherein the feature restriction program is configured to restrict at least one of: incoming calls; outgoing calls; incoming text messages; outgoing text messages; incoming video messages; outgoing video messages; incoming email; outgoing email; instant messaging access; incoming instant messages, outgoing instant messages; internet access; game access; music or video access; camera access; accessing or editing contact information; accessing or editing calendar information; accessing or editing call history information; accessing or editing stored files; or accessing a wireless data transfer system.

6. The portable communication device of claim 5 wherein restricting incoming calls comprises at least one of: restricting all incoming calls; restricting numbers from which incoming calls may be received; or restricting the time of connection for incoming calls.

7. The portable communication device of claim 5 wherein restricting outgoing calls comprises at least one of: restricting all outgoing calls; restricting numbers which may be called; or restricting the time of connection for outgoing calls.

8. A feature restriction program stored on a machine readable medium, the feature restriction program being suitable for use in a portable electronic device, wherein when the feature restriction program is loaded in memory in the portable electronic device and executed, the feature restriction program causes the portable electronic device to be configured at least in part:
to receive user profile information comprising password information; and
to enable restricted access to at least one of the plurality of features based upon the received user profile information.

9. The portable communication device of claim 8 wherein the feature restriction program is configured to require a user to enter user profile information before the user is able to access at least one of the plurality of features.

10. The portable communication device of claim 8 wherein the feature restriction program is configured to require a user to enter user profile information after the portable communication device is powered on.

11. The portable communication device of claim 8 wherein the feature restriction program is configured to restrict at least one of: incoming calls; outgoing calls; incoming text messages; outgoing text messages; incoming video messages; outgoing video messages; incoming email; outgoing email; instant messaging access; incoming instant messages, outgoing instant messages; internet access; game access; music or video access; camera access; accessing or editing contact information; accessing or editing calendar information; accessing or editing call history information; accessing or editing stored files; or accessing a wireless data transfer system.

12. The portable communication device of claim 11 wherein restricting incoming calls comprises at least one of: restricting all incoming calls; restricting numbers from which incoming calls may be received; or restricting the time of connection for incoming calls.

13. The portable communication device of claim 11 wherein restricting outgoing calls comprises at least one of: restricting all outgoing calls; restricting numbers which may be called; or restricting the time of connection for outgoing calls.

14. A method for restricting features on a portable electronic device comprising:
a) receiving user profile information comprising password information at the portable electronic device;
b) associating the received user profile information with at least one portable electronic device feature;
c) receiving a user input requesting access to at least one portable electronic device feature;
d) determining whether the at least one portable electronic device feature is associated with the received user profile information; and
e) enabling the requested access to the at least one portable electronic device feature upon a positive determination in step d).

15. The method of claim 14 further comprising restricting access to the at least one portable electronic device feature upon a negative determination in step d).

16. The method of claim 14 wherein the at least one portable electronic device feature is at least one of: receiving incoming calls; making outgoing calls; receiving incoming text messages; sending outgoing text messages; receiving incoming video messages; sending outgoing video messages; receiving incoming email; sending outgoing email; accessing instant messaging; receiving incoming instant messages, sending outgoing instant messages; accessing the internet; accessing a game; accessing music or video; accessing a camera; accessing or editing contact information; accessing or editing calendar information; accessing or editing call history information; accessing or editing stored files; or accessing a wireless data transfer system.

17. The method of claim 16 further comprising at least one of: restricting all incoming calls; restricting numbers from which incoming calls may be received; or restricting the time of connection for incoming calls.

18. The method of claim 16 further comprising at least one of: restricting all outgoing calls; restricting numbers which may be called; or restricting the time of connection for outgoing calls.
